(19) United States
(12) Patent Application Publication
(10) Pub. No.: US 2023/0211854 A1
(43) Pub. Date: Jul. 6, 2023

(54) AMPHIBIOUS UNMANNED PATROL VEHICLE CAPABLE OF REAL-TIME COMMUNICATION

(71) Applicant: Beijing Institute of Technology, Beijing (CN)

(72) Inventors: Tairan CHEN, Beijing (CN); Jiacheng CHEN, Beijing (CN); Zeyang LI, Beijing (CN); Haoran LIU, Beijing (CN); Biao HUANG, Beijing (CN); Guoyu WANG, Beijing (CN)

(21) Appl. No.: 17/967,350

(22) Filed: Oct. 17, 2022

(30) Foreign Application Priority Data
Jan. 6, 2022 (CN) 202210010436.3

(51) Int. Cl. B63B 22/00; B60F 3/00; B63B 22/04; B63B 22/18; B63H 11/02

(52) U.S. Cl. CPC B63B 22/003; B60F 3/0015; B60F 3/0038; B63B 22/04; B63B 22/18; B63H 11/02

(57) ABSTRACT

The amphibious unmanned patrol vehicle includes a buoy, a waterproof cable and a submersible amphibious vehicle. An end of the waterproof cable is connected to a first controller of the buoy; and another end thereof is connected to a second controller of the submersible amphibious vehicle. A bottom end of the buoy is connected to a top end of the submersible amphibious vehicle which is configured to realize movement and operation of a whole system. The waterproof cable is configured to connect the submersible amphibious vehicle, and the buoy configured to ensure real-time communication between the submersible amphibious vehicle and an external environment during operation of the submersible amphibious vehicle. A height difference between an upper surface and a lower surface of the automatic reeling and unreeling cable device is equal to a thickness of the waterproof cable. The length of the waterproof cable is adjusted automatically in real time.

### CROSS REFERENCE TO RELATED APPLICATION

This patent application claims the benefit and priority of Chinese Patent Application No.202210010436.3 filed on Jan. 6, 2022, the disclosure of which is incorporated by reference herein in its entirety as part of the present application.

### TECHNICAL FIELD

The present disclosure relates to an amphibious unmanned patrol vehicle capable of real-time communication, and belongs to the technical field of amphibious vehicles.

### BACKGROUND

Amphibious unmanned patrol vehicles are special vehicles with dual functions of travelling on land and underwater. The amphibious unmanned patrol vehicle can complete many tasks, such as reconnaissance and surveillance, and hydrological data collection. However, the underwater communication mode for the amphibious vehicles has been restricted. At present, the technology most widely used in the underwater communication is underwater acoustic communication technology. Compared with electromagnetic waves in the air, the data transmission rate for the underwater acoustic communication is greatly reduced. Due to the limitation of transmission bandwidth, the underwater acoustic communication technology cannot transmit characters, images and other data quickly. Furthermore, during the transmission process in the shallow water, signals may undergo relatively strong frequency selective fading and attenuation in the time domain, which, together with the noise caused by water temperatures, fluctuations and marine biological activities, make underwater acoustic wave transmission, especially in the shallow water, extremely difficult. Therefore, it is extremely necessary to provide a signal transmission mechanism between the unmanned amphibious vehicles and the monitoring terminals to broaden application scenarios of the amphibious unmanned patrol vehicles.

### SUMMARY

An object of the present disclosure is to provide an amphibious unmanned patrol vehicle capable of real-time communication, so that the amphibious vehicle can still communicate with the base station in time underwater. An automatic reeling and unreeling cable device can adjust a length of a waterproof cable in real time according to a submergence depth of the amphibious vehicle, in order to enable the waterproof cable to be always in a tightened state and ensure synchronous movement of the amphibious vehicle and the buoy, and to avoid the waterproof cable from tangling with obstacles due to looseness, thereby avoiding the abnormal cable from affecting operation of the amphibious unmanned patrol vehicle, and ensuring real-time communication effect and reliability.

The object of the present disclosure is achieved by the following technical solution.

The present disclosure provides an amphibious unmanned patrol vehicle capable of real-time communication, including a buoy capable of real-time communication, navigation and positioning, a waterproof cable and a submersible amphibious vehicle. An end of the waterproof cable is connected with a first controller of the buoy; another end thereof is connected with a second controller of the amphibious vehicle; a bottom end of the buoy is connected with a top end of the amphibious vehicle.

The submersible amphibious vehicle is configured to realize movement and operation of a whole system. The waterproof cable is configured to connect the submersible amphibious vehicle and the buoy. The buoy is configured to implement real-time communication between the submersible amphibious vehicle and an external environment during operation of the submersible amphibious vehicle. When the submersible amphibious vehicle operates on land, the buoy and the submersible amphibious vehicle are fixedly connected by an electromagnetic clamping block and an electromagnetic clamping slot, and the submersible amphibious vehicle carries the buoy to move together; upon a switch from operating on land to operating underwater, the electromagnetic clamping slot is powered off, and an automatic reeling and unreeling cable device unreels the waterproof cable in real time, such that the buoy is separated from the submersible amphibious vehicle; when the submersible amphibious vehicle operates underwater, the buoy floats on a water surface, and the automatic reeling and unreeling cable device automatically adjusts a length of the waterproof cable in real time according to a submergence depth of the submersible amphibious vehicle; the waterproof cable is always in a tightened state so as to avoid the waterproof cable from tangling with obstacles due to looseness, and to realize synchronous movement in position of the buoy and the submersible amphibious vehicle.

In some embodiments, the buoy capable of real-time communication, navigation and positioning, includes a wind vane, an image transmission camera, a protective cover, a low-speed motor, bevel gears, the electromagnetic clamping slot, the automatic reeling and unreeling cable device, a battery pack, the first controller, a transmission shaft, a navigation and positioning module, a communication module and a stand.

The buoy is divided into three portions: an upper layer, a lower layer and an upper layer top. The upper layer includes the low-speed motor, the bevel gears, the battery pack, the first controller and the transmission shaft. The automatic reeling and unreeling cable device is placed at the lower layer; the navigation and positioning module, the communication module and the stand are located at the upper layer top; the stand is located at an upper side of the upper layer of the buoy; the wind vane is located on an upper side of the stand and outside the protective cover to indicate a wind direction on the water surface. The protective cover is made of transparent material, and the image transmission camera is located on the stand within the protective cover and configured to monitor and investigate surrounding water surface environment conditions; the communication module is located below the stand and configured to transmit a wind speed and a wind direction, images of surrounding water surface, positioning, and surrounding environmental information and operation conditions of the submersible amphibious vehicle observed by the buoy to a base station, and to receive instructions from the base station, so as to realize data communication between a buoy-amphibious vehicle system and the base station. The navigation and positioning module is located below the stand for real-time navigation and positioning of the buoy-amphibious vehicle system. The battery pack is located at a right side of the upper layer within the buoy to supply power to the buoy; the low-speed motor is located at a left side of the upper layer within the buoy and configured to drive the automatic reeling and unreeling cable device to operate. The first controller is connected with the communication module and the low-speed motor to receive the instructions from the base station and control the motor to operate. The electromagnetic clamping slot is fixedly connected with the buoy for fixing with the submersible amphibious vehicle when the submersible amphibious vehicle operates on land.

In some embodiments, the automatic reeling and unreeling cable device is cylindrical and located at the lower layer of the buoy. A height difference between an upper surface and a lower surface of the automatic reeling and unreeling cable device is equal to a thickness of the waterproof cable, which ensures that the waterproof cable is only wound on an outside of the automatic reeling and unreeling cable device during reeling, so as to avoid tangling. A top surface of the automatic reeling and unreeling cable device is fixed, and a bottom surface thereof rotates along with a middle transmission shaft to drive the waterproof cable to be reeled and unreeled, so as to adjust the length of the waterproof cable in real time according to the submergence depth of the submersible amphibious vehicle, so that the waterproof cable is always in the tightened state. The automatic reeling and unreeling cable device is driven by the low-speed motor located on the upper layer, and power is transmitted through a pair of bevel gears so as to realize changes of transmission directions. An upper half of the transmission shaft is hollow, and the waterproof cable is connected to the first controller at the upper layer through the upper half of the transmission shaft. The waterproof cable is reeled and unreeled by the automatic reeling and unreeling cable device, such that the waterproof cable is in a tensioned state, to allow synchronous movement of the amphibious vehicle and the buoy in position, and avoid the waterproof cable from tangling with obstacles due to looseness.

In some embodiments, the submersible amphibious vehicle adopts a streamlined drag reduction profile and rudder control surface, and includes a dorsal fin, a first water-jet propeller, a waterproof pressure sensor, a follower wheel, a caterpillar band support frame, a floating wheel, a drive hub motor, a caterpillar band, a pectoral fin, a high-definition camera, a second water-jet propeller capable of rotating clockwise and anti-clockwise, the second controller and the electromagnetic clamping block. The submersible amphibious vehicle submerges freely to a required depth to complete water surface and underwater operations. When the submersible amphibious vehicle operates on land, the caterpillar band rotates 90° with the caterpillar band support frame to drive the submersible amphibious vehicle forward; upon the switch from operating on land to operating underwater, the caterpillar band is reeled to an abdomen of the submersible amphibious vehicle with the caterpillar band support frame; when the submersible amphibious vehicle operates underwater, the caterpillar band does not work, and the submersible amphibious vehicle is pushed forward by the first water-jet propeller .

In some embodiments, the waterproof cable is made of a special waterproof cable. The waterproof cable may be made of a lightweight cable that is capable of being reeled and unreeled repeatedly, and formed of: a conductor made of oxygen-free pure copper, an insulation surface made of polyvinyl chloride material that is wear-resistant, stable and corrosion-resistant, and an outer layer including a special waterproof film and waterproof rubber, such that use requirements of the submersible amphibious vehicle operating underwater for a long time are met, with advantages of softness, wear resistance and tensile strength involved.

In some embodiments, the navigation and positioning module selects a Beidou navigation and positioning module. The communication module adopts 5G communication module.

The present disclosure also provides an operation method of the amphibious unmanned patrol vehicle capable of real-time communication, including:
controlling the low-speed motor o rotate by the first controller in the buoy and in turn driving the automatic reeling and unreeling cable device through transmission of the bevel gears to completely reel the waterproof cable into the buoy when the amphibious vehicle operates on land; controlling the battery pack by the first controller in the buoy to supply power to the electromagnetic clamping slot, to magnetically attract the electromagnetic clamping block on a top of the submersible amphibious vehicle thereby realizing a fixed connection between the buoy and the submersible amphibious vehicle, such that the buoy is carried by the submersible amphibious vehicle to move together;
transmitting pressure information to the second controller in the submersible amphibious vehicle in real time by the waterproof pressure sensor, to convert the pressure information into a depth signal which is then transmitted to the first controller in the buoy through the waterproof cable when the submersible amphibious vehicle is ready to launch; controlling the battery pack to power off the electromagnetic clamping slot when it is determined that the diving depth is equal to a height of the submersible amphibious vehicle, such that the buoy is separated from the submersible amphibious vehicle, and the buoy floats on water surface under action of buoyancy; at this moment, controlling the low-speed motor to rotate by the first controller in the buoy to drive the automatic reeling and unreeling cable device to unreel the waterproof cable;
transmitting the pressure information to the first controller in the submersible amphibious vehicle in real time by the waterproof pressure sensor as the submersible amphibious vehicle continues to submerge, to convert the pressure information into depth information which is then transmitted to the first controller in the buoy through the waterproof cable, controlling the automatic reeling and unreeling cable device to unreel the waterproof cable to a given length in real time; wherein when the submersible amphibious vehicle operates underwater, the automatic reeling and unreeling cable device is driven by the low-speed motor located on the upper layer and power is transmitted through the pair of bevel gears, so as to change transmission directions; the upper half of the transmission shaft is hollow, and the waterproof cable is connected to the first controller at the upper layer through the upper half of the transmission shaft; the waterproof cable is reeled and unreeled by the automatic reeling and unreeling cable device, and a length of the waterproof cable is adjusted in real time according to a submerge depth of the submersible amphibious vehicle, such that the waterproof cable is always in a tightened state to allow synchronous movement of the submersible amphibious vehicle and the buoy, and prevent the waterproof cable from tangling with obstacles due to looseness;
wherein when the submersible amphibious vehicle performs functional tasks, data and surrounding environment information collected are transmitted to the second controller in the submersible amphibious vehicle, and transmitted to the first controller in the buoy through the waterproof cable; data exchange is implemented between the base station and the submersible amphibious vehicle through the communication module; on one hand, operation data of the submersible amphibious vehicle is transmitted, on another hand, corresponding instructions from the base station are received so as to control the submersible amphibious vehicle to perform corresponding tasks;
wherein the buoy is equipped with the navigation and positioning module, as the buoy and the submersible amphibious vehicle are always in synchronous movement, the base station locating the submersible amphibious vehicle by positioning the buoy; the submersible amphibious vehicle is provided with the waterproof pressure sensor that senses a depth thereof in real time, so as to realize accurate positioning of the submersible amphibious vehicle; the image transmission camera at the upper layer of the buoy observes surrounding water surface conditions; in combination with the high-definition camera in the submersible amphibious vehicle, all-round observation of water surface and underwater operation environment for the amphibious vehicle is realized, thereby facilitating real-time control of the submersible amphibious vehicle.

The present disclosure has the following beneficial effects.

1. In order to overcome the disadvantage that the traditional amphibious vehicle cannot communicate with the base station in time underwater, the amphibious unmanned patrol vehicle capable of real-time communication, disclosed by the present disclosure, adopts the buoy equipped with the communication module and the navigation and positioning module, and the buoy is connected with the submersible amphibious unmanned patrol vehicle through the waterproof cable, so that the buoy-amphibious vehicle system can realize real-time communication with the base station, thereby facilitating giving instructions flexibly according to the operation environment and controlling the unmanned amphibious patrol vehicle in real time.

2. The amphibious unmanned patrol vehicle capable of real-time communication, disclosed by the present disclosure, adopts the waterproof cable, and the waterproof cable is always in a tensioned state through the automatic reeling and unreeling cable device, such that the amphibious vehicle and the buoy can move simultaneously, thereby facilitating positioning the amphibious vehicle in real time, and avoiding a case in which tangling with obstacles due to looseness affects operation of the amphibious vehicle.

3. The amphibious unmanned patrol vehicle capable of real-time communication, disclosed by the present disclosure, adopts the automatic reeling and unreeling cable device. The automatic reeling and unreeling cable device is cylindrical, and a height difference between the upper surface and the lower surface of the automatic reeling and unreeling cable device is equal to the thickness of the waterproof cable, so as to ensure that the cable can only be wound on the outside of the automatic reeling and unreeling cable device when it is reeled, and to avoid tangling.

4. For the amphibious unmanned patrol vehicle capable of real-time communication, provided by the present disclosure, when the amphibious vehicle is operating underwater, the automatic reeling and unreeling cable device is driven by the low-speed motor located on the upper layer, and power is transmitted through the pair of bevel gears, so as to realize changes of the transmission direction. The upper half of the transmission shaft is hollow, and the waterproof cable is connected to the first controller through the upper half of the transmission shaft. The waterproof cable is reeled and unreeled by the automatic reeling and unreeling cable device. The length of the waterproof cable is adjusted in real time according to the submergence depth of the amphibious vehicle, and the waterproof cable is ensured to be in a tensioned state, so that the amphibious vehicle and the buoy move synchronously, thereby avoiding the problem of entanglement of the waterproof cable with obstacles due to looseness.

5. In the amphibious unmanned patrol vehicle capable of real-time communication, disclosed by the present disclosure, the internal space of the buoy is arranged in layers according to functions and volumes of the related parts and working relationships among the related parts, which can further realize compact layout on the basis of ensuring working reliability.

6. In the amphibious unmanned patrol vehicle capable of real-time communication, disclosed by the present disclosure, the image transmission camera at the upper layer of the buoy can observe surrounding water surface conditions, and combined with the high-definition camera in the amphibious vehicle, it can realize all-round observation of the water surface and underwater operation environment for the amphibious vehicle, thereby facilitating real-time control of the amphibious unmanned patrol vehicle.

### BRIEF DESCRIPTION OF THE DRAWINGS

FIG. 1 is a schematic diagram showing an overall structure of an amphibious unmanned patrol vehicle capable of real-time communication, when operating underwater, according to the present disclosure;

FIG. 2 is a view of the amphibious unmanned patrol vehicle capable of real-time communication, when operating underwater, according to the present disclosure;

FIG. 3 is a view of the amphibious unmanned patrol vehicle capable of real-time communication, when operating on land, according to the present disclosure;

FIG. 4 is a schematic diagram showing an internal structure of a buoy capable of real-time communication, navigation and positioning, according to the present disclosure;

FIG. 5 is a schematic diagram showing a main structure of a submersible amphibious vehicle, according to the present disclosure;

FIG. 6 is a schematic diagram showing a caterpillar band position of the submersible amphibious unmanned patrol vehicle, when operating underwater, according to the present disclosure;

Reference numerals: 1 buoy, 2 cable, 3 submersible amphibious vehicle, 4 wind vane, 5 image transmission camera, 6 protective cover, 7 low-speed motor, 8 bevel gear, 9 electromagnetic clamping slot, 10 automatic reeling and unreeling cable device, 11 battery pack, 12 first controller, 13 transmission shaft, 14 navigation and positioning module, 15 communication module, 16 stand, 17 dorsal fin, 18 first water-jet propeller, 19 waterproof pressure sensor, 20 follower wheel, 21 caterpillar band support frame, 22 floating wheel, 23 drive hub motor, 24 caterpillar band, 25 pectoral fin, 26 high definition camera, 27 second water-jet propeller, 28 second controller, 29 electromagnetic clamping block

### DETAILED DESCRIPTION

In order to illustrate the purpose and advantages of the present disclosure in more details, the present disclosure is further described below in combination with the accompanying drawings and the embodiments.

### Embodiment 1

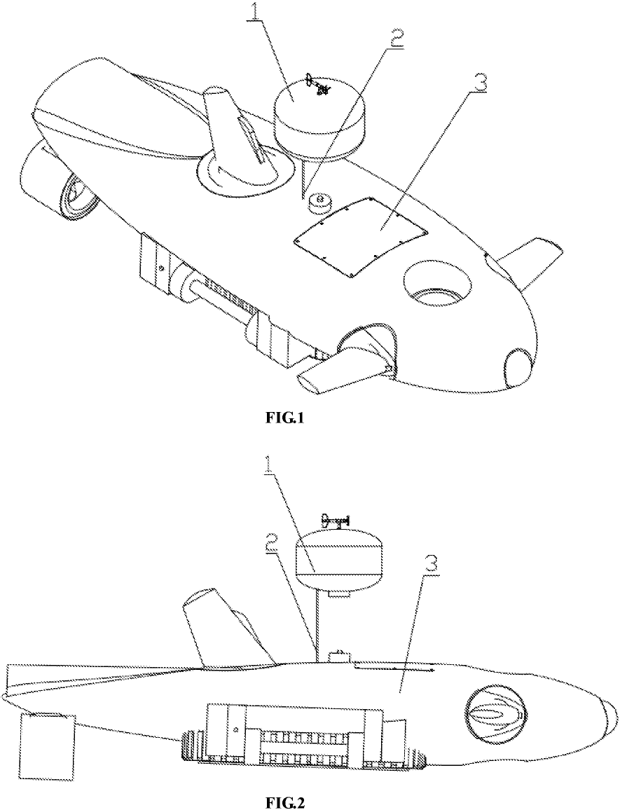

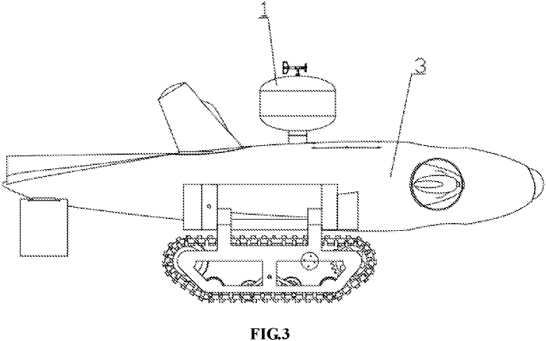

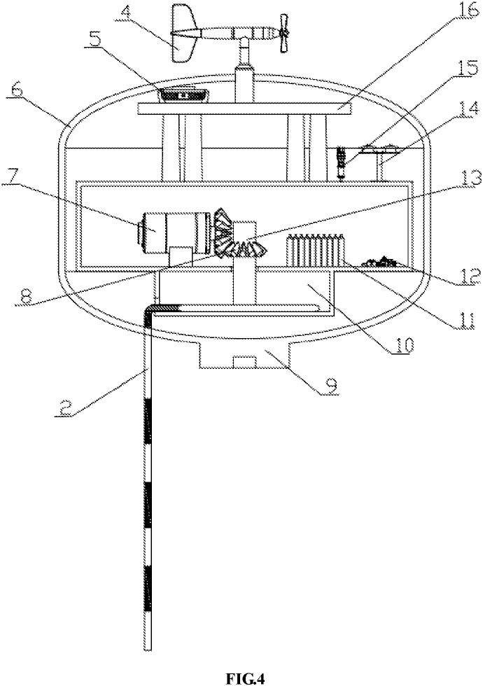

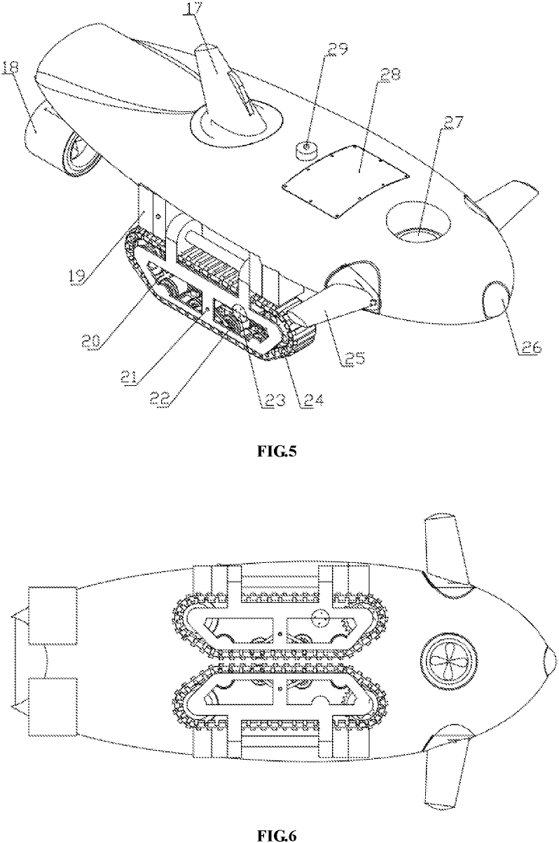

As shown in FIG. 1, this embodiment discloses an amphibious unmanned patrol vehicle capable of real-time communication. During underwater operation, the amphibious unmanned patrol vehicle can communicate with a base station in real time, through a buoy equipped with a 5G communication module and a waterproof cable connecting the buoy to the submersible amphibious vehicle, so that the base station can effectively determine operation environment around the submersible amphibious vehicle.

The amphibious unmanned patrol vehicle capable of real-time communication, disclosed by the embodiment, includes a buoy 1 capable of real-time communication, navigation and positioning, a waterproof cable 2 and a submersible amphibious vehicle 3. The submersible amphibious vehicle 3 is responsible for movement and operation of a whole system; the waterproof cable 2 connects the amphibious vehicle 3 with the buoy 1, and the buoy 1 is used to ensure real-time communication between the amphibious vehicle 3 and an external environment when the amphibious vehicle 3 operates underwater.

The buoy 1 is configured for real-time communication, navigation and positioning, and formed through rolling a metal plate into a cylinder by a plate rolling machine and then welding the cylinder. The buoy 1 is divided into three portions: an upper layer space, a lower layer space and an upper layer top. The upper layer is mainly configured for containing various functional module devices, such as a low-speed motor 7 driving the waterproof cable 2 to be reeled in and out, bevel gears 8 for changing a direction, a central controller 12 for the whole buoy system, and a battery pack 11.

The waterproof cable 2 is made of lightweight cable that can be reeled in and out repeatedly, which is formed with a conductor made of oxygen-free pure copper, an insulation surface made of polyvinyl chloride material that is wear-resistant, stable and corrosion-resistant, and an outer layer having a waterproof film and waterproof rubber. Therefore, the waterproof cable 2 can meet use requirements of the amphibious vehicle 3 operating underwater for long-time, and has characteristics such softness, wear resistance and tensile strength.

The Beidou navigation and positioning module 14 is placed on a top of the upper layer of the buoy 1 and compatible with the GPS, the Beidou system and the Russian satellite system, and further has advantages of high positioning precision and supporting a plurality of navigation modes, such as waypoint navigation, track navigation and route navigation. A height of the Beidou navigation and positioning module 14 is about 120 millimeters (mm), and a width thereof is about 45 mm. In order to adapt to harsh environment such as sea and field, a surface of the Beidou navigation and positioning module 14 needs to be subjected to waterproof, salt-spray proof and anti-corrosion treatments.

The communication module 15 is placed on the top of the upper layer of the buoy 1, adopts M.2 package compatible with 5G/4G/3G, and supports 5GNSA and SA modes, so as to meet demands on rapid communication in different operation environments on water surface. The communication module 15 has a size of 52 mm × 30 mm × 2.3 mm and a weight of about 9 g, and operates at an operation temperature ranging from - 40° C. to 85° C.

The automatic reeling and unreeling cable device 10 is located at the lower layer of the buoy 1 and is in a shape of a cylinder. An upper surface of the device is fixed, and a lower surface thereof is fixed with a transmission shaft 13 and rotates with the transmission shaft 13. A round hole is provided on a side of the device 10, out of which the waterproof cable 2 extends. An O-shaped sealing ring is provided at the round hole to realize dynamic sealing. The transmission shaft 13 is hollow, and the waterproof cable 2 passes through the transmission shaft 13 to the upper layer and is connected to the first controller 12, so as to collect and transmit the data obtained by the amphibious vehicle 3.

The submersible amphibious vehicle 3 adopts a shape of a bionic fish. When the submersible amphibious vehicle 3 operates on land, the caterpillar band 24 rotates 90° with the caterpillar band support frame 21, to drive the amphibious vehicle 3 forward. Upon the switch from operating on land to operating underwater, the caterpillar band 24 is reeled to an abdomen of the amphibious vehicle 3 with the caterpillar band support frame 2. When the amphibious vehicle 3 operates underwater, the caterpillar band 24 does not work, and the amphibious vehicle 3 is pushed forward by a first water-jet propeller 18. Operation environment images captured by a high definition camera 26 is transmitted to a second controller 28 in the amphibious vehicle 3, and then transmitted to the first controller 12 in the buoy 1 through the waterproof cable 2, so as to realize data transmission.

An operating method of the amphibious unmanned patrol vehicle capable of real-time communication disclosed in this embodiment is described as follows.

When the amphibious vehicle 3 operates on land, the first controller 12 in the buoy 1 controls the low-speed motor 7 to rotate and in turn drive the automatic reeling and unreeling cable device 10 through the transmission of the bevel gears 8, to completely reel the waterproof cable 2 into the buoy 1. The first controller 12 in the buoy 1 controls the battery pack 11 to supply power to an electromagnetic clamping slot 9 so that the electromagnetic clamping slot 9 is attracted to the electromagnetic clamping block 29 on a top of the amphibious vehicle 3 through magnetic force, thereby realizing a fixed connection between the buoy 1 and the amphibious vehicle 3. Thus, the amphibious vehicle 3 carries the buoy 1 to move together.

When the amphibious vehicle 3 is ready to launch, a waterproof pressure sensor 19 transmits pressure information to the second controller 28 in the amphibious vehicle 3 in real time, so as to convert the pressure information into a depth signal, which is then transmitted to the first controller 12 in the buoy 1 through the waterproof cable 2. When it is determined that a submergence depth is equal to a height of the amphibious vehicle 3, the first controller 12 in the buoy 1 controls the battery pack 11 to power off the electromagnetic clamping slot 9, such that the buoy 1 is separated from the amphibious vehicle 3 and floats on the water surface under action of buoyancy. At this moment, the first controller 12 in the buoy 1 controls the low-speed motor 7 to rotate, and drives the automatic reeling and unreeling cable device 10 to unreel the waterproof cable 2.

As the amphibious vehicle 3 continues to submerge, the waterproof pressure sensor 19 transmits the pressure information to the second controller 28 in the amphibious vehicle 3 in real time, to convert the pressure information into depth information, which is then transmitted to the first controller 12 in the buoy 1 through the waterproof cable 2, thereby controlling the automatic reeling and unreeling cable device 10 to unreel the cable 2 to a suitable length in real time. When the amphibious vehicle 3 needs to operate underwater, according to the required submergence depth of the amphibious vehicle 3, the first controller 12 in the buoy 1 controls the low-speed motor 7 to rotate and in turn drive the automatic reeling and unreeling cable device 10 through the transmission of the bevel gears 8 to unreel the waterproof cable 2 to a suitable length which allows the waterproof cable to be just in a tensioned state. At this moment, the amphibious vehicle 3 and the buoy 1 can realize synchronous movement in position. When the amphibious vehicle 3 performs tasks, the data collected by the amphibious vehicle 3 may be transmitted to the second controller 28 in the amphibious vehicle 3, and transmitted to the first controller 12 in the buoy 1 through the waterproof cable 2. The amphibious vehicle 3 performs the data exchange with the base station through the 5G communication module 15. On one hand, operation data of the amphibious vehicle 3 may be transmitted, and on the other hand, corresponding instructions from the base station may be received, so as to control the amphibious vehicle 3 to perform the corresponding tasks.

In addition, the buoy 1 is equipped with the Beidou navigation and positioning module 14, so that the base station can determine the position of the amphibious vehicle 3 by positioning the buoy 1. The waterproof pressure sensor 19 is provided in the amphibious vehicle 3, and can sense the depth of the amphibious vehicle 3 underwater, so that the accurate positioning of the amphibious vehicle 3 can be realized. A protective cover 6 is made of transparent material. An image transmission camera 5 can observe the surrounding water surface conditions through the protective cover 6. In combination with the high-definition camera 26 in the amphibious vehicle 3, the image transmission camera 5 can realize all-round observation of the water surface and underwater operation environment around the amphibious vehicle 3, thereby facilitating real-time control of the amphibious vehicle 3.

In order to solve the problem that the existing amphibious vehicle 3 cannot perform data transmission with the base station when operating underwater, the amphibious unmanned patrol vehicle capable of real-time communication disclosed by the present disclosure transmits the data obtained by the amphibious vehicle 3 to the buoy 1 through the buoy 1 capable of real-time communication, navigation and positioning, the waterproof cable 2 and the submersible amphibious vehicle 3, thereby achieving communication with the base station. In this embodiment, the waterproof cable 2 is reeled in and out in real time according to the submergence depth of the amphibious vehicle 3 through the automatic reeling and unreeling cable device 10, and is always in a tensioned state, thereby realizing the synchronous movement of the amphibious vehicle 3 and the buoy 1 and avoiding the problem of tangling of the waterproof cable 2 due to looseness. In this embodiment, after the buoy 1 is positioned through the Beidou navigation and positioning module 14, in combination with the data of the waterproof pressure sensor 19, the amphibious vehicle 3 can be positioned accurately. In this embodiment, the combination of the image transmission camera 5 in the buoy 1 and the high definition camera 26 in the amphibious vehicle 3 realizes the all-round observation of the water surface and underwater operation environment for the amphibious vehicle 3, thereby facilitating the real-time control of the amphibious vehicle 3.

The above specific description further describes the purpose, technical solution and beneficial effects of the present disclosure. It should be understood, the above description is only a specific embodiment of the present disclosure and is not used to limit the protection scope of the present disclosure. Any modification, equivalent replacement, improvement, etc. made within the spirit and principles of the present disclosure should be included in the protection scope of the present disclosure.

What is claimed is:

1. An amphibious unmanned patrol vehicle capable of real-time communication, comprising:
a buoy capable of real-time communication, navigation and positioning;
a waterproof cable; and
a submersible amphibious vehicle;
wherein an end of the waterproof cable is connected with a first controller of the buoy, another end thereof is connected with a second controller of the submersible amphibious vehicle; and a bottom end of the buoy is connected with a top end of the submersible amphibious vehicle;
wherein the submersible amphibious vehicle is configured to realize movement and operation of a whole system;
wherein the waterproof cable is configured to connect the submersible amphibious vehicle and the buoy;
wherein the buoy is configured to implement real-time communication between the submersible amphibious vehicle and an external environment during operation of the submersible amphibious vehicle;
wherein when the submersible amphibious vehicle operates on land, the buoy and the submersible amphibious vehicle are fixedly connected by an electromagnetic clamping block and an electromagnetic clamping slot, and the submersible amphibious vehicle carries the buoy to move together;
wherein upon a switch from operating on land to operating underwater, the electromagnetic clamping slot is powered off, and an automatic reeling and unreeling cable device unreels the waterproof cable in real time, such that the buoy is separated from the submersible amphibious vehicle;
wherein when the submersible amphibious vehicle operates underwater, the buoy floats on a water surface, and the automatic reeling and unreeling cable device automatically adjusts a length of the waterproof cable in real time according to a submergence depth of the submersible amphibious vehicle;
wherein the waterproof cable is always in a tightened state so as to avoid the waterproof cable from tangling with obstacles due to looseness, and to realize synchronous movement in position of the buoy and the submersible amphibious vehicle.

2. The amphibious unmanned patrol vehicle capable of real-time communication according to claim 1, wherein the buoy capable of real-time communication, navigation and positioning, comprises a wind vane, an image transmission camera, a protective cover, a low-speed motor, bevel gears, the electromagnetic clamping slot, the automatic reeling and unreeling cable device, a battery pack, the first controller, a transmission shaft, a navigation and positioning module, a communication module, and a stand;
wherein the buoy is divided into three portions comprising an upper layer, a lower layer and an upper layer top; wherein the upper layer comprises the low-speed motor, the bevel gears, the battery pack, the first controller, and the transmission shaft;
wherein the automatic reeling and unreeling cable device is placed at the lower layer;
wherein the navigation and positioning module, the communication module and the stand are located at the upper layer top;
wherein the stand is located at an upper side of the upper layer of the buoy, the wind vane is located on an upper side of the stand and outside the protective cover to indicate a wind direction on the water surface;
wherein the protective cover is made of transparent material, and the image transmission camera is located on the stand within the protective cover and configured to monitor and investigate surrounding water surface environment conditions;
wherein the communication module is located below the stand and configured to transmit a wind speed and a wind direction, images of surrounding water surface, positioning, and surrounding environmental information and operation conditions of the submersible amphibious vehicle observed by the buoy to a base station, and to receive instructions from the base station, so as to realize data communication between a buoy-amphibious vehicle system and the base station;
wherein the navigation and positioning module is located below the stand for real-time navigation and positioning of the buoy-amphibious vehicle system;
wherein the battery pack is located at a right side of the upper layer within the buoy to supply power to the buoy;
wherein the low-speed motor is located at a left side of the upper layer within the buoy and configured to drive the automatic reeling and unreeling cable device to operate;
wherein the first controller is connected with the communication module and the low-speed motor to receive the instructions from the base station and control the motor to operate;
wherein the electromagnetic clamping slot is fixedly connected with the buoy for fixing with the submersible amphibious vehicle when the submersible amphibious vehicle operates on land.

3. The amphibious unmanned patrol vehicle capable of real-time communication according to claim 1, wherein the automatic reeling and unreeling cable device is cylindrical and located at the lower layer of the buoy;
wherein a height difference between an upper surface and a lower surface of the automatic reeling and unreeling cable device is equal to a thickness of the waterproof cable, which ensures that the waterproof cable is only wound on an outside of the automatic reeling and unreeling cable device during reeling, so as to avoid tangling;
wherein a top surface of the automatic reeling and unreeling cable device is fixed, and a bottom surface thereof rotates along with a middle transmission shaft to drive the waterproof cable to be reeled and unreeled, so as to adjust the length of the waterproof cable in real time according to the submergence depth of the submersible amphibious vehicle, so that the waterproof cable is always in the tightened state;
wherein the automatic reeling and unreeling cable device is driven by the low-speed motor located on the upper layer, and power is transmitted through a pair of bevel gears so as to realize changes of transmission directions;
wherein an upper half of the transmission shaft is hollow, and wherein the waterproof cable is connected to the first controller at the upper layer through the upper half of the transmission shaft;
wherein the waterproof cable is reeled and unreeled by the automatic reeling and unreeling cable device, such that the waterproof cable is in a tensioned state, to allow synchronous movement of the amphibious vehicle and the buoy in position, and avoid the waterproof cable from tangling with obstacles due to looseness.

4. The amphibious unmanned patrol vehicle capable of real-time communication according to claim 1, wherein the waterproof cable is made of a light weight cable that is capable of being reeled and unreeled repeatedly, and formed of: a conductor made of oxygen-free pure copper, an insulation surface made of polyvinyl chloride material that is wear-resistant, stable and corrosion-resistant, and an outer layer comprising a waterproof film and waterproof rubber.

5. The amphibious unmanned patrol vehicle capable of real-time communication according to claim 1, wherein the submersible amphibious vehicle adopts a streamlined drag reduction profile and rudder control surface, and comprises a dorsal fin, a first water-jet propeller, a waterproof pressure sensor, a follower wheel, a caterpillar band support frame, a floating wheel, a drive hub motor, a caterpillar band, a pectoral fin, a high-definition camera, a second water-jet propeller capable of rotating clockwise and anti-clockwise, the second controller and the electromagnetic clamping block, wherein the submersible amphibious vehicle submerges freely to a required depth to complete water surface and underwater operations;
wherein when the submersible amphibious vehicle operates on land, the caterpillar band rotates 90° with the caterpillar band support frame to drive the submersible amphibious vehicle forward;
wherein upon the switch from operating on land to operating underwater, the caterpillar band is reeled to an abdomen of the submersible amphibious vehicle with the caterpillar band support frame;
wherein when the submersible amphibious vehicle operates underwater, the caterpillar band does not work, and the submersible amphibious vehicle is pushed forward by the first water-jet propeller.

6. The amphibious unmanned patrol vehicle capable of real-time communication according to claim 1, wherein the navigation and positioning module comprises a Beidou navigation and positioning module and is compatible with GPS, Beidou system and Russian satellite navigation and positioning system;
wherein the communication module comprises a 5G communication module.

7. A method of operating an amphibious unmanned patrol vehicle capable of real-time communication, the amphibious unmanned patrol vehicle comprising a buoy capable of real-time communication, navigation and positioning, a waterproof cable and a submersible amphibious vehicle;
wherein an end of the waterproof cable is connected with a first controller of the buoy; another end thereof is connected with a second controller of the submersible amphibious vehicle, and a bottom end of the buoy is connected with a top end of the submersible amphibious vehicle;
wherein the submersible amphibious vehicle is configured to realize movement and operation of a whole system; wherein the waterproof cable is configured to connect the submersible amphibious vehicle and the buoy; wherein the buoy is configured to implement real-time communication between the submersible amphibious vehicle and an external environment during operation of the submersible amphibious vehicle; wherein when the submersible amphibious vehicle operates on land, the buoy and the submersible amphibious vehicle are fixedly connected by an electromagnetic clamping block and an electromagnetic clamping slot, and the submersible amphibious vehicle carries the buoy to move together; wherein upon a switch from operating on land to operating underwater, the electromagnetic clamping slot is powered off, and an automatic reeling and unreeling cable device unreels the waterproof cable in real time, such that the buoy is separated from the submersible amphibious vehicle; wherein when the submersible amphibious vehicle operates underwater, the buoy floats on a water surface, and the automatic reeling and unreeling cable device automatically adjusts a length of the waterproof cable in real time according to a submergence depth of the submersible amphibious vehicle; the waterproof cable is always in a tightened state so as to avoid the waterproof cable from tangling with obstacles due to looseness, and to realize synchronous movement in position of the buoy and the submersible amphibious vehicle;
wherein the method comprises:
controlling the low-speed motor to rotate by the first controller in the buoy, and in turn driving the automatic reeling and unreeling cable device through transmission of the bevel gears to completely reel the waterproof cable into the buoy when the amphibious vehicle operates on land;
controlling the battery pack by the first controller in the buoy to supply power to the electromagnetic clamping slot, to magnetically attract the electromagnetic clamping block on a top of the submersible amphibious vehicle, thereby realizing a fixed connection between the buoy and the submersible amphibious vehicle, such that the buoy is carried by the submersible amphibious vehicle to move together;
transmitting pressure information to the second controller in the submersible amphibious vehicle in real time by the waterproof pressure sensor, to convert the pressure information into a depth signal which is then transmitted to the first controller in the buoy through the waterproof cable when the submersible amphibious vehicle is ready to launch;
controlling the battery pack to power off the electromagnetic clamping slot when it is determined that the diving depth is equal to a height of the submersible amphibious vehicle, such that the buoy is separated from the submersible amphibious vehicle, and the buoy floats on water surface under the action of buoyancy;
controlling the low-speed motor to rotate by the first controller in the buoy to drive the automatic reeling and unreeling cable device to unreel the waterproof cable;
transmitting the pressure information to the first controller in the submersible amphibious vehicle in real time by the waterproof pressure sensor as the submersible amphibious vehicle continues to submerge, to convert the pressure information into depth information which is then transmitted to the first controller in the buoy through the waterproof cable;
controlling the automatic reeling and unreeling cable device to unreel the waterproof cable in real time;
wherein when the submersible amphibious vehicle operates underwater, the automatic reeling and unreeling cable device is driven by the low-speed motor located on the upper layer and power is transmitted through the pair of bevel gears, so as to change transmission directions; the upper half of the transmission shaft is hollow, and the waterproof cable is connected to the first controller at the upper layer through the upper half of the transmission shaft; the waterproof cable is reeled and unreeled by the automatic reeling and unreeling cable device, and a length of the waterproof cable is adjusted in real time according to a submerge depth of the submersible amphibious vehicle, such that the waterproof cable is always in a tightened state to allow synchronous movement of the submersible amphibious vehicle and the buoy, and prevent the waterproof cable from tangling with obstacles due to looseness;
wherein when the submersible amphibious vehicle performs functional tasks, data and surrounding environment information collected are transmitted to the second controller in the submersible amphibious vehicle, and transmitted to the first controller in the buoy through the waterproof cable;
wherein data exchange is implemented between the base station and the submersible amphibious vehicle through the communication module;
wherein operational data of the submersible amphibious vehicle is transmitted, corresponding instructions from the base station are received so as to control the submersible amphibious vehicle to perform corresponding tasks;
wherein the buoy includes the navigation and positioning module, the buoy and the submersible amphibious vehicle in synchronous movement, the base station locating the submersible amphibious vehicle by positioning the buoy;
wherein the submersible amphibious vehicle including the waterproof pressure sensor that senses a depth thereof in real time, so as to realize accurate positioning of the submersible amphibious vehicle; and
wherein the image transmission camera observes surrounding water surface conditions in combination with the high-definition camera in the submersible amphibious vehicle to enable all-around observation of water surface and underwater operation environment for the amphibious vehicle, thereby facilitating real-time control of the submersible amphibious vehicle.

8. The method according to claim 7, wherein the buoy capable of real-time communication, navigation and positioning, comprises a wind vane, an image transmission camera, a protective cover, a low-speed motor, bevel gears, the electromagnetic clamping slot, the automatic reeling and unreeling cable device, a battery pack, the first controller, a transmission shaft, a navigation and positioning module, a communication module and a stand;
wherein the buoy is divided into an upper layer, a lower layer, and an upper layer top, the upper layer comprising the low-speed motor, the bevel gears, the battery pack, the first controller and the transmission shaft;
wherein the automatic reeling and unreeling cable device is placed at the lower layer;
wherein the navigation and positioning module, the communication module and the stand are located at the upper layer top;
wherein the stand is located at an upper side of the upper layer of the buoy;
wherein the wind vane is located on an upper side of the stand and outside the protective cover to indicate a wind direction on the water surface;
wherein the protective cover is made of transparent material, and the image transmission camera is located on the stand within the protective cover and configured to monitor and investigate surrounding water surface environment conditions;
wherein the communication module is located below the stand and configured to transmit a wind speed and a wind direction, images of surrounding water surface, positioning, and surrounding environmental information and operation conditions of the submersible amphibious vehicle observed by the buoy to a base station, and to receive instructions from the base station, so as to realize data communication between a buoy-amphibious vehicle system and the base station;
wherein the navigation and positioning module is located below the stand for real-time navigation and positioning of the buoy-amphibious vehicle system;
wherein the battery pack is located at a right side of the upper layer within the buoy to supply power to the buoy;
wherein the low-speed motor is located at a left side of the upper layer within the buoy and configured to drive the automatic reeling and unreeling cable device to operate;
wherein the first controller is connected with the communication module and the low-speed motor to receive the instructions from the base station and control the motor to operate;
wherein the electromagnetic clamping slot is fixedly connected with the buoy for fixing with the submersible amphibious vehicle when the submersible amphibious vehicle operates on land.

9. The method according to claim 7, wherein the automatic reeling and unreeling cable device is cylindrical and located at the lower layer of the buoy;
wherein a height difference between an upper surface and a lower surface of the automatic reeling and unreeling cable device is equal to a thickness of the waterproof cable, ensuring that the waterproof cable is only wound on an outside of the automatic reeling and unreeling cable device during reeling thereby avoiding tangling;
wherein a top surface of the automatic reeling and unreeling cable device is fixed, and a bottom surface thereof rotates along with a middle transmission shaft to drive the waterproof cable to be reeled and unreeled, so as to adjust the length of the waterproof cable in real time according to the submergence depth of the submersible amphibious vehicle, so that the waterproof cable is always in the tightened state;
wherein the automatic reeling and unreeling cable device is driven by the low-speed motor located on the upper layer, and power is transmitted through a pair of bevel gears so as to realize changes of transmission directions;
wherein an upper half of the transmission shaft is hollow, and the waterproof cable is connected to the first controller at the upper layer through the upper half of the transmission shaft;
wherein the waterproof cable is reeled and unreeled by the automatic reeling and unreeling cable device, such that the waterproof cable is in a tensioned state, to allow synchronous movement of the amphibious vehicle and the buoy in position, and avoid the waterproof cable from tangling with obstacles due to looseness.

10. The method according to claim 7, wherein the waterproof cable is made of a light weight cable that is capable of being reeled and unreeled repeatedly, and formed of: a conductor made of oxygen-free pure copper, an insulation surface made of polyvinyl chloride material that is wear-resistant, stable and corrosion-resistant, and an outer layer comprising a waterproof film and waterproof rubber.

11. The method according to claim 7, wherein the submersible amphibious vehicle comprises a streamlined drag reduction profile and rudder control surface, a dorsal fin, a first water-jet propeller, a waterproof pressure sensor, a follower wheel, a caterpillar band support frame, a floating wheel, a drive hub motor, a caterpillar band, a pectoral fin, a high-definition camera, a second water-jet propeller capable of rotating clockwise and anti-clockwise, the second controller and the electromagnetic clamping block, wherein the submersible amphibious vehicle submerges freely to a required depth for water surface and underwater operations; wherein when the submersible amphibious vehicle operates on land, the caterpillar band rotates 90° with the caterpillar band support frame to drive the submersible amphibious vehicle forward; wherein upon the switch from operating on land to operating underwater, the caterpillar band is reeled to an abdomen of the submersible amphibious vehicle with the caterpillar band support frame; wherein when the submersible amphibious vehicle operates underwater, the caterpillar band does not work, and the submersible amphibious vehicle is pushed forward by the first water-jet propeller.

12. The operation method according to claim 7, wherein the navigation and positioning module comprises a Beidou navigation and positioning module and is compatible with GPS, Beidou system and Russian satellite navigation and positioning system; and
wherein the communication module comprises a 5G communication module.
